(19) United States
(12) Patent Application Publication
(10) Pub. No.: US 2007/0051913 A1
(43) Pub. Date: Mar. 8, 2007

(54) Fluid control apparatus and manufacturing method thereof

(75) Inventors: Katsuya Torii, Anjo-city (JP); Masamichi Akagawa, Kariya-city (JP); Yasushi Kawano, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/514,147

(22) Filed: Sep. 1, 2006

(30) Foreign Application Priority Data
Sep. 2, 2005 (JP) 2005-254935

(51) Int. Cl. F16K 1/22

(52) U.S. Cl. 251/305

(57) ABSTRACT

In a manufacturing method of a fluid control apparatus, a valve integrally formed with a valve shaft is assembled inside a housing. First and second bearing members are assembled inside the housing by inserting each of the first and second bearing members into a corresponding space between the housing and the valve shaft from a corresponding longitudinal end side of the valve shaft. A longitudinal position of the valve relative to the housing is adjusted through one of the following methods. A first contact portion is brought into contact with a first side face, and a second contact portion is brought into contact with a second side face. A first contact surface is brought into contact with a first longitudinal end face, and a second contact surface is brought into contact with a second longitudinal end face.

### CROSS REFERENCE TO RELATED APPLICATION

This application is based on and incorporates herein by reference Japanese Patent Application No. 2005-254935 filed on Sep. 2, 2005.

### BACKGROUND OF THE INVENTION

1. Field of the Invention

The present invention relates to a fluid control apparatus and a manufacturing method thereof, the fluid control apparatus controlling a fluid, which flows through a fluid passage formed inside a housing, and more particularly, to an internal combustion engine intake air control apparatus and a manufacturing method thereof, the internal combustion engine intake air control apparatus controlling intake air, which flows through a intake air passage. Here, the intake air passage communicates with a cylinder of the internal combustion engine.

2. Description of Related Art

Recently, for example, Japanese Unexamined Patent Publication No. 2003-509634 (P.1 to 9, FIGS. 1 to 6) discloses an internal combustion engine intake air control apparatus, which includes a housing and a valve received in the housing, wherein the housing and the valve are made of a resin material in consideration of a weight reduction, a thermal insulating property and a design flexibility. Here, the resin housing is formed with an intake air passage that communicates with a cylinder of the internal combustion engine, and the resin valve is received in the housing such that the valve opens and closes to control intake air that flows through the intake air passage. As shown in FIG. 10, a resin valve 102 is assembled to a resin housing 101, which is structured as an elastic body, to form a valve unit. The valve unit is mounted on an intake manifold of an internal combustion engine. Here, the valve 102 is formed integrally with a valve shaft 103. The housing 101 includes an intake air passage 104 and a pair of bearing support holes 105 formed on both sides of the intake air passage 104.

It has been disadvantageously more difficult to attain a high degree of accuracy in molding vehicle components, such as engine intake components, which are made of a resin material, compared to a case of a metallic material. Thus, for example, when a bearing clearance between a valve shaft 103 of the valve 102 and the bearing support hole 105 of the housing 101 is reduced, a friction resistance between the housing 101 and the valve shaft 103 becomes increased. Therefore, the bearing clearance between the hosing 101 and the valve shaft 103 needs to be increased beforehand in order to attain a smooth and non-interferential rotation performance of the valve 102 when the valve 102 has been assembled inside the housing 101. Further, each side clearance between the housing 101 and the valve 102 also needs to be increased beforehand. In the above valve unit, when leakage of the intake air from side clearances of both sides are equal to each other, atomization of fuel, which is injected through an injection hole of a fuel injection valve, is facilitated such that an engine performance and fuel economy can be improved. Thus, the side clearances specially need to be set at appropriate values.

However, in the conventional technique, the side clearances of both sides may not be disadvantageously equalized as shown in FIG. 10 (i.e.,δL<δR or δL >δR), because a longitudinal position of the valve 102 is determined based on the side clearance between the housing 101 and the valve 102. Thus, in some cases, the atomization of the fuel has not been reliably facilitated.

Also in the conventional technique, inner peripheral portions of the bearing support holes 105 of the housing 101 serve as bearings, which pivotally support the valve shaft 103. Also, the valve 102 includes a shaft function (the valve shaft 103). Thus, at least one of the housing 101 and the valve 102, needs to be resin molded by use of a certain resin composition material. Here, the certain resin composition material is formed by mixing the resin material with an expensive low friction resistance material, which is slidable, such as polytetrafluoroethylene resin (PTFE). This result in increasing cost.

Further, in the conventional technique, because the housing 101 is structured as an elastic body, the intake manifold is distorted when the valve unit is assembled to the intake manifold and the intake manifold is airtightly fastened to the cylinder of the engine by use of fasten bolts. Then, when the distortion of the intake manifold reaches the housing 101, the housing 101 may be twisted. Thus, a coaxiality of the bearing support holes 105 may deteriorate. In a case of a four-cylinder intake manifold, where four valve units are assembled, due to the above distortion, a shaft slide torque may be disadvantageously increased when the valve units 2 have been connected with each other by a single metallic shaft. In a worst case, this may result in that a drive actuator cannot open or close the valve units 2.

### SUMMARY OF THE INVENTION

It is an objective of the present invention to provide a fluid control apparatus and a manufacturing method thereof, the fluid control apparatus obviating or mitigating at least one of the above disadvantages.

To achieve the objective of the present invention, there is provided a manufacturing method of a fluid control apparatus. In the manufacturing method, a valve that is integrally formed with a valve shaft is assembled inside a housing. First and second bearing members are assembled inside the housing by inserting each of the first and second bearing members into a corresponding space between the housing and the valve shaft from a corresponding longitudinal end side of the valve shaft. A longitudinal position of the valve relative to the housing in a longitudinal direction of the valve shaft is adjusted through one of the following methods. A first contact portion of the first bearing member is brought into contact with a first side face of the valve and a second contact portion of the second bearing member is brought into contact with a second side face of the valve. A first contact surface of the first bearing member is brought into contact with a first longitudinal end face of the valve shaft and a second contact surface of the second bearing member is brought into contact with a second longitudinal end face of the valve shaft.

To achieve the objective of the present invention, there is also provided a fluid control apparatus, which includes a resin housing, a resin valve, a valve shaft, and first and second bearing members. The resin housing includes a fluid passage inside the housing. The resin valve is received in the housing such that the valve opens and closes the fluid passage to control fluid that passes through the fluid passage. The valve shaft is formed integrally with the valve. The first and second bearing members are received inside the housing such that each of the first and second bearing members slidably pivotally supports a corresponding longitudinal end portion of the valve shaft, the valve shaft being rotatable in a rotation direction. The first bearing member includes one of a first contact portion that contacts a first side face of the valve, and a first contact surface that contacts a first longitudinal end face of the valve shaft. The second bearing member includes one of a second contact portion that contacts a second side face of the valve, and a second contact surface that contacts a second longitudinal end face of the valve shaft. The housing includes a longitudinal position control member that controls a longitudinal position of each of the first and second bearing members relative to the housing in a longitudinal direction of the valve shaft such that a first side clearance between a first wall face of the housing and the first side face of the valve is generally equalized to a second side clearance between a second wall face of the housing and the second side face of the valve.

To achieve the objective of the present invention, there is also provided a fluid control apparatus, which includes a resin housing, a resin valve, a valve shaft, and first and second bearing members. The resin housing includes a fluid passage inside the housing. The resin valve is received in the housing such that the valve opens and closes the fluid passage to control fluid that passes through the fluid passage. The valve shaft is formed integrally with the valve. The first and second bearing members are received inside the housing such that each of the first and second bearing members slidably pivotally supports a corresponding longitudinal end portion of the valve shaft, the valve shaft being rotatable in a rotation direction, wherein at least one of the first and second bearing members is integrally formed by use of a resin composite material, which includes a resin material and a low friction resistance material that is mixed with or added to the resin material.

To achieve the objective of the present invention, there is also provided a fluid control apparatus, which includes a resin housing, a resin valve, a valve shaft, and first and second bearing members. The resin housing includes a fluid passage inside the housing. The resin valve is received in the housing such that the valve opens and closes the fluid passage to control fluid that passes through the fluid passage. The valve shaft is formed integrally with the valve. The first and second bearing members are received inside the housing such that each of the first and second bearing members slidably pivotally supports a corresponding longitudinal end portion of the valve shaft, the valve shaft being rotatable in a rotation direction. The first bearing member includes a first adjusting member, through which the first bearing member engages with the housing at a first position relative to the housing. The second bearing member includes a second adjusting member, through which the second bearing member engages with the housing at a second position relative to the housing.

### BRIEF DESCRIPTION OF THE DRAWINGS

The invention, together with additional objectives, features and advantages thereof, will be best understood from the following description, the appended claims and the accompanying drawings in which:

FIG. 1A is a sectional view of a valve unit according to a first embodiment;

FIG. 1B is another sectional view of a valve unit according to the first embodiment;

FIG. 2 is a perspective view of an internal combustion engine intake air control apparatus according to the first embodiment;

FIG. 3 is an exploded view of the internal combustion engine intake air control apparatus according to the first embodiment;

FIG. 4A is a sectional view of a valve unit according to a second embodiment;

FIG. 4B is another sectional view of a valve unit according to the second embodiment;

FIG. 5A is a sectional view of a periphery of an example of a first bearing according to a third embodiment;

FIG. 5B is a sectional view of the periphery of another example of the first bearing according to the third embodiment;

FIG. 5C is a sectional view of the periphery of another example of the first bearing according to the third embodiment;

FIG. 5D is a sectional view of the periphery of another example of the first bearing according to the third embodiment;

FIG. 6A is a sectional view of a periphery of a first bearing according to a fourth embodiment;

FIG. 6B is another sectional view of the periphery of the first bearing according to the fourth embodiment;

FIG. 7A is a sectional view of a molding die for an injection molding according to a fifth embodiment;

FIG. 7B is a drawing taken along line VIIB-VIIB in FIG. 7A;

FIG. 8A is a sectional view of a valve unit according to the fifth embodiment;

FIG. 8B is another sectional view of the valve unit according to the fifth embodiment;

FIG. 8C is a drawing taken along a line VIIIC-VIIIC of FIG. 8B;

FIG. 9A is another sectional view of the valve unit according to the fifth embodiment;

FIG. 9B is a drawing taken along a line IXB-IXB of FIG. 9A; and

FIG. 10 is a sectional view of a valve unit according to a related art.

### DETAILED DESCRIPTION OF PREFERRED EMBODIMENTS

(First Embodiment)

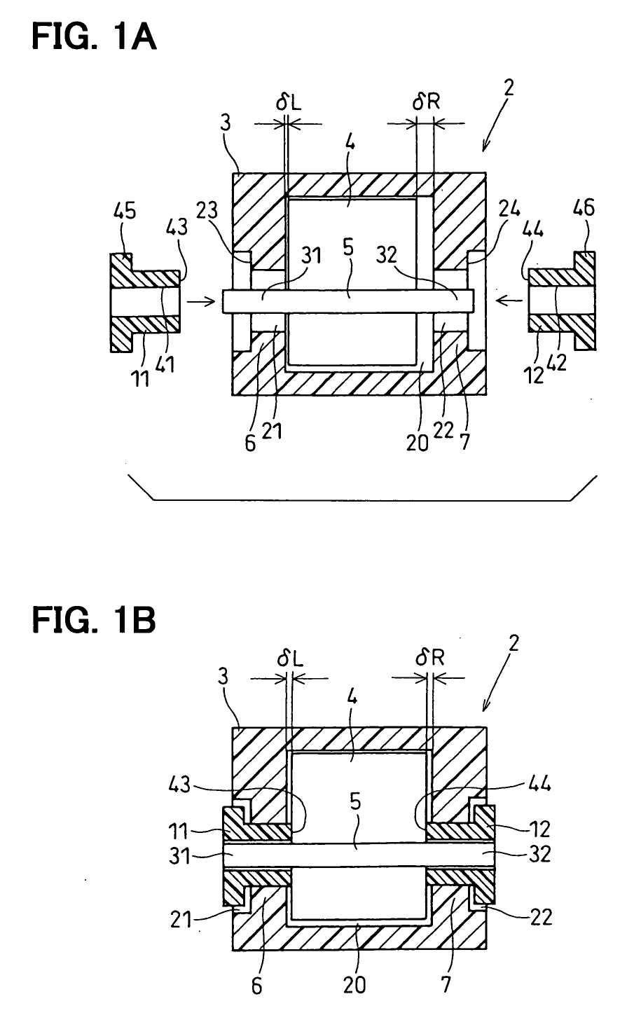

A first embodiment of the present invention will be described with reference to FIGS. 1A to 3. A structure of the first embodiment of the present invention will be described.

An internal combustion engine intake air control apparatus of the present embodiment is an intake air flow generating apparatus (a vortex flow generating apparatus), which can generate intake air vortex flow in a vertical direction (tumble flow) for facilitating combustion of air-fuel mixture in each cylinder of a multi-cylinder internal combustion engine mounted on a vehicle. The multi-cylinder internal combustion engine includes, for example, a four-cylinder gasoline engine, and will be indicated as an engine hereinafter. The engine obtains power based on a thermal energy generated by burning the mixture of intake air and the fuel in a combustion chamber. The engine includes a cylinder head (not shown) and a cylinder block (not shown). The cylinder head is airtightly connected with a downstream end of an intake air pipe. The air-fuel mixture is introduced to the combustion chamber, which is formed by the cylinder block, through each intake port, which is provided to the cylinder head and is formed into a three dimensional intake air passage shape.

Here, a spark plug (not shown) is provided to the combustion chamber of each cylinder such that an end portion of the spark plug is exposed inside the combustion chamber. Also, the cylinder head includes injectors (not shown), each of which injects fuel into the intake port at a proper timing. Each of multiple intake ports formed on one side of the cylinder head is opened and closed by a corresponding poppet intake valve. Also, each of multiple exhaust ports formed on another side of the cylinder head is opened and closed by a corresponding poppet exhaust valve.

The intake air pipe includes an air cleaner, an air cleaner case, a throttle body, a surge tank and an intake manifold. The air cleaner (a filter element) filters the intake air. The air cleaner case houses and supports the air cleaner. The throttle body is located downstream of the air cleaner case in an intake air flow direction. The surge tank is located downstream of the throttle body. The intake manifold is located downstream of the surge tank. The intake manifold serves as a manifold for the intake air and distributes the intake air, which flows into the intake manifold, to each intake port of the cylinder provided to the cylinder head of the engine. The intake manifold is made of a resin material for reducing a weight and a cost, and is integrally formed with (by use of) the resin material (e.g., a glass-fiber reinforced thermoplastic resin).

Then, the intake air flow generating apparatus is provided integrally with the intake air pipe, which forms the intake air passage that communicates with the cylinder (combustion chamber) of the engine. The intake air flow generating apparatus includes a casing 1, multiple valve units 2 and multiple annular gaskets 9. The casing 1 is formed into a rectangular parallelepiped shape, which forms a part of the intake air pipe of the engine. Each of the multiple valve units 2 is housed inside the casing 1. Each of the annular gaskets (a rubber elastic body, a floating rubber) 9 airtightly seals a connection between a downstream end portion of the intake air pipe and an upstream end portion of the casing 1. Here, the intake air pipe includes an intake air duct, throttle body, the surge tank and the intake pipe). In other words, the internal combustion engine intake air control apparatus structures an intake air flow control valve module (multi integrated intake air flow control valve open and close apparatus), in which the valve units 2 are arranged in a line by predetermined intervals inside the common casing 1. Here, each valve unit 2 includes a housing 3 and an intake air flow control valve 4, which is assembled to the housing 3 such that the intake air flow control valve 4 opens and closes an air passage of the housing 3.

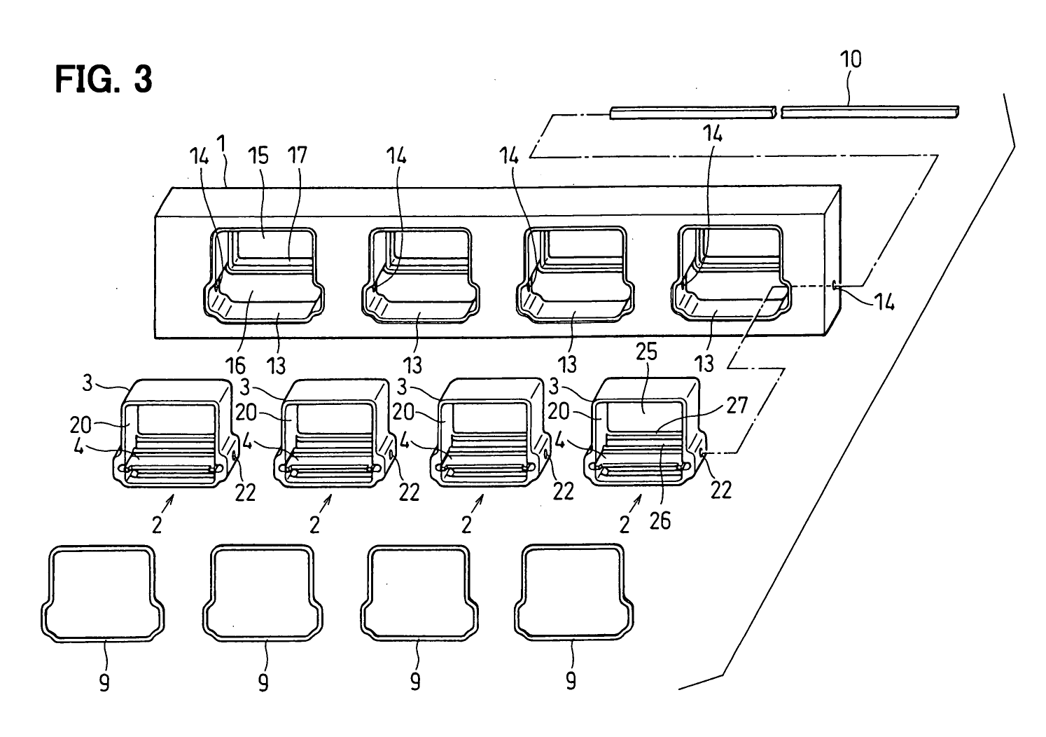

Here, the number of the multiple valve units 2, which are provided, corresponds to the number of the cylinders of the engine. As shown in FIG. 3, each of the multiple valve units 2 includes the housing 3, the intake air flow control valve 4, the valve shaft 10 and first and second bearings (bearing members) 11, 12. The housing 3 forms the air passage, which communicates with a corresponding cylinder (combustion chamber) of the engine, and a cross section of the air passage of the housing 3 is formed into a rectangular shape. The intake air flow control valve 4 is received in the housing 3 operable for opening and closing. The multiple intake air flow control valves 4 are designed to be integrated with each other. The valve shaft 10 connects multiple control valves 4 of the multiple valve units 2 together such that the multiple control valves 4 work together. The first and second bearings 11, 12 are inserted between the housing 3 and the intake air flow control valve 4. Here, the valve shaft 10 is made of an iron metallic material and has a polygonal cross section (e.g., a square-shaped cross section) perpendicular to a longitudinal axis of the valve shaft 10.

The casing 1 of the present embodiment is a block (a vehicle component, engine component, resin intake manifold), which forms a part of or an entire of the intake manifold. The casing 1 is integrally formed into a rectangular parallelopiped shape with a resin material, (e.g., a thermoplastic resin). The casing 1 includes multiple fit bores 13, each of which receives and supports each housing 3 of the valve units 2. The casing 1 includes shaft through holes 14 that extend in a direction from one side wall portion of the casing 1 (right side in FIG. 3) to another side wall portion (left side in FIG. 3) such that the shaft through holes 14 communicate with (extend through) all the fit bores 13. In other words, the shaft through holes 14 are arranged in the casing 1 to extend in an orthogonal direction to a flow axial direction of an average flow of the intake air, which flows through the air passages. Here, the orthogonal direction serves as a reference longitudinal direction. The casing 1 integrally includes separation wall portions 17, each of which are formed on an end face of an intake port side of the casing 1. Therefore, a corresponding portion of the casing 1 that corresponds to a downstream side (the intake port side) of each air passage 20 formed in the housing 3 is sectioned into a first air passage 15 and a second air passage 16 by each of the separation wall portions 17. Here, the separation wall portion 17 is formed into a polygonal tubular shape. The first air passage 15 is located on an upper side and the second air passage 16 is located on a lower side.

The multiple housings 3 are all made of the resin material, and each of the houses 3 is integrally formed into a predetermined shape by use of the resin material, such as the thermoplastic resin. Each housing 3 includes an air passage (fluid passage) 20, which is defined by four faces (two pairs of opposites faces). A cross section of the air passage 20 is a generally rectangular shape. The housing 3 includes passage wall faces. The passage wall faces include vertical passage wall faces, each of which is located on either up or down side in FIGS. 1A to 3 of the air passage 20. The passage wall faces also include horizontal passage wall faces, each of which is located on either left of right side in FIGS. 1A to 3 of the air passage 20. The vertical (up and down side) passage wall faces of the housing 3 are longer than the horizontal (left and right side) passage wall faces of the housing 3. Alternatively, the vertical passage wall faces may be shorter depending on a shape of the apparatus (casing, housing).

The housing 3 integrally includes first and second bearing holders (first and second bearing receiving members) 6, 7 on both longitudinal ends of the housing 3 in the reference longitudinal direction. Here, the reference longitudinal direction is orthogonal to the flow axis direction of the average flow of the intake air, which flows through the air passage 20. The first and second bearing holders 6, 7 respectively includes first and second bearing support holes 21, 22, a cross section of each of which is a circle. The first bearing 11 is assembled to the first bearing support hole 21, and the second bearing 12 is assembled to the second bearing support hole 22. The first and second bearing support holes 21, 22 include first and second annular step surfaces (contact portions) 23, 24 respectively. Diameters of the first and second bearing support holes 21, 22 are smaller on the air passage sides of the first and second step surfaces 23, 24 than on opposite sides of the first and second step surfaces 23, 24, respectively. Here, the opposite sides are opposite from the air passage sides.

As shown in FIG. 3, the housing 3 integrally includes a separation wall portion 27, which is formed on an end face of an intake port side of the housing 3. Therefore, a downstream side (the intake port side) of the air passage 20 is sectioned into a first air passage 25 and a second air passage 26 by the separation wall portions 27. Here, the separation wall portion 27 is formed into a polygonal tubular shape. The first air passage 25 is located on an upper side to communicate with the first air passage 15 of the casing 1, and the second air passage 26 is located on the lower side to communicate with the second air passage 16 of the casing 1. The first and second air passages 25, 26 and the separation wall portion 27 may not be provided to the housing 3. Also, the first and second air passages 15, 16 and the separation wall portion 17 may not be provided to the casing 1.

Each of the multi integral intake air flow control valves 4 is an intake air flow control valve, which is formed integrally with the valve shaft 5 (i.e., intake manifold intake air switching valve). Each of the multi integral intake air flow control valves 4 is made of the resin material and is formed into a predetermined shape with the resin material, such as the thermoplastic resin material. The intake air flow control valve 4 is a butterfly valve, which rotates about an rotational axis that extends in the reference longitudinal direction. Here, the reference longitudinal direction is orthogonal to the axis direction of the average flow of the intake air, which flows through the air passage 20 in an axial direction of the housing 3. The rotational axis of the intake air flow control valve 4 is decentered and is located lower than a center position in a vertical direction (a height direction) of the housing 3 in FIGS. 1A, 1B. Thus, the intake air flow control valve 4 is a cantilever valve.

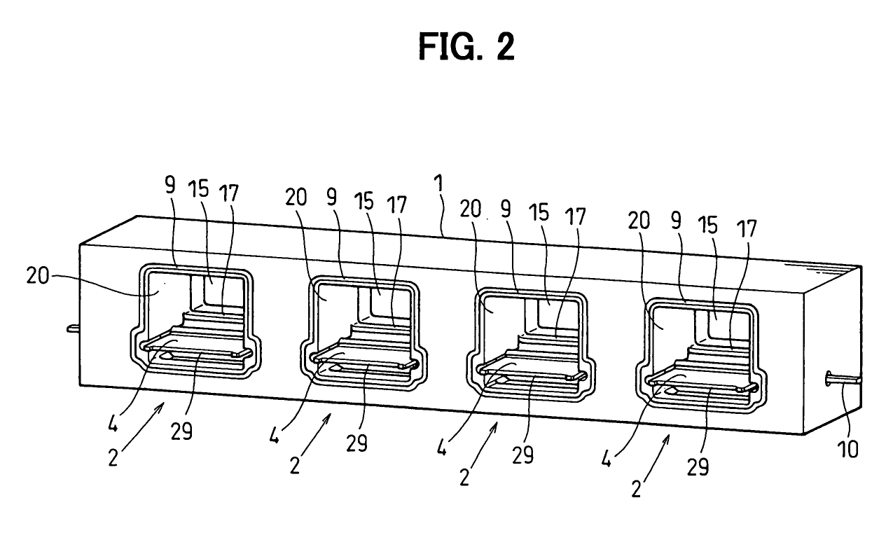

The intake air flow control valve 4 is a generally rectangular shape, which is defined by four sides that include two pairs of opposite sides. The intake air flow control valve 4 includes horizontal side faces (first and second side faces), each of which is located on a left or right side in FIGS. 1A, 1B, and vertical end faces, each of which is located on an up or down side in FIGS. 1A, 1B. The vertical end faces are longer than the horizontal side faces. Alternatively, the vertical end faces may be shorter depending on a shape of the apparatus (casing, housing). The intake air flow control valve 4 is received in the air passage 20 of the housing 3 such that the intake air flow control valve 4 opens and closes (i.e., the control valve 4 is rotatable). As shown in FIG. 2, the intake air flow control valve 4 may includes an opening portion 29, which is formed by cutting a center portion of an upper end face of the intake air flow control valve 4 (i.e., an upper portion of the air passage 20). Thus, a predetermined intake air flow can be formed between the housing 3 and the intake air flow control valve 4. The opening portion 29 may not be formed. Another opening portion (slit) may be formed by cutting a lower end face or a part of the horizontal side face of the intake air flow control valve 4. The another opening portion forms a predetermined intake air flow between the housing 3 and the intake air flow control valve 4.

Here, in the present embodiment, in a state where the intake air flow control valve 4 closes the air passage 20, in other words, in a state where the intake air flow control valve 4 is located in a totally closed position such that a flow amount of the intake air flowing through the air passage 20 becomes minimum (valve in the totally closed position), a longitudinal position of the intake air flow control valve 4 is set such that a side clearance (first side clearance) (δL) generally equals a side clearance (second side clearance) (δR) as shown in FIG. 1B. Here, the side clearance (δL) is formed between a left passage wall face (first wall face) of the housing 3 and a left side face (first side face) of the intake air flow control valve 4. Similarly, the side clearance (δR) is formed between a right passage wall face (second wall face) of the housing 3 and a right side face (second side face) of the intake air flow control valve 4. Thus, the injector may be provided to a position such that the injection hole of the injector is adjacently provided to an air flow, which passes through the side clearance (δL) or the side clearance (δR) toward the combustion chamber in a state where the valve is in the totally closed position,.

The valve shaft 5, which is a cylindrical tube, is formed integrally at a vicinity of a rotation axis of the intake air flow control valve 4. Here, the valve shaft 5 is rotatably received in the first and second bearing holders 6, 7. The valve shaft 5 extends in the reference longitudinal direction. The valve shaft 5 includes a shaft through hole (not shown), through which the valve shaft 10 extends in the reference longitudinal direction. A cross sectional shape of the shaft through hole of the valve shaft 5 is of a form, which is generally identical to that of the valve shaft 10 such that a relative movement of the intake air flow control valve 4 relative to the valve shaft 10 is controlled.

One longitudinal end portion of the valve shaft 5 projects from the left side face of the intake air flow control valve 4 in the reference longitudinal direction, and the one longitudinal end portion is fitted in the first bearing 11. An outer peripheral surface of the one longitudinal end portion of the valve shaft 5 serves as a first bearing slide portion 31, which is rotatably slidable to the first bearing holder 6 of the housing 3 through the first bearing 11. Another longitudinal end portion of the valve shaft 5 projects from the right side face of the intake air flow control valve 4 in the reference longitudinal direction, and the another longitudinal end portion is fitted in the second bearing 12. An outer peripheral surface of the another longitudinal end portion of the valve shaft 5 serves as a second bearing slide portion 32, which is rotatably slidable to the second bearing holder 7 of the housing 3 through the second bearing 12.

Here, in a case where the valve shaft 10, a cross sectional shape of which is a polygon, is directly supported by the first and second bearing holders 6, 7 of the housing 3, the valve shaft 10 can not be rotated smoothly. Thus, the valve shaft 10 is covered by the valve shaft 5 of the intake air flow control valve 4, and an outer peripheral surface of the valve shaft 10 is pivotally supported by the first and second bearings 11, 12 through the both longitudinal end portions (first and second bearing slide portions 31, 32) of the valve shaft 5. Each of the multi integrated intake air flow control valves 4 is supported and fixed by the single valve shaft 10.

A valve drive apparatus for opening and closing operations of the multi integrated intake air flow control valves 4 of the present embodiment includes a electric actuator with a power unit. The power unit includes an electric motor, which is driven using electricity, and a power transmission mechanism (a gear reducer mechanism in the present embodiment), which transmits a rotational movement of a motor shaft (output shaft) of the electric motor to the valve shaft 10. A direct current motor (DC motor) (e.g., a brushless DC motor, a brush DC motor) serves as the electric motor. An alternating current motor (AC motor) (e.g., a three-phase induction motor) may serve as the electric motor. Also, the gear reducer mechanism reduces a rotational speed of the motor shaft of the electric motor by a predetermined reduction ratio. The gear reducer mechanism constitutes the power transmission mechanism that transmits a motor output shaft torque (drive power) of the electric motor to the valve shaft 10. The valve drive apparatus, specially the electric motor, is structured for being electrically controlled by an engine control unit (ECU).

The first and second bearings 11, 12 are made of the resin material, and is integrally formed into a cylindrical tubular shape with the resin material, such as the thermoplastic resin material. The first and second bearings 11, 12 are integrally assembled to hole wall faces (inner peripheries) of the first and second bearing support holes 21, 22 of the first and second bearing holders 6, 7, respectively. More particularly, the first and second bearings 11, 12 are integrally assembled to the hole wall faces of small hole portions of the first and second bearing support holes 21, 22, the small hole portions being located inside (the air passage side) of the first and second step surfaces 23, 24, respectively. The first and second bearings 11, 12 includes first and second slide holes 41, 42, a cross section of each of which is formed into a circle, respectively. The first and second slide holes 41, 42 pivotally support the longitudinal end portions (the first and second bearing slide portions 31, 32) of the valve shaft 5, which is formed integrally formed with the intake air flow control valve 4, such that the longitudinal end portions can slide in the rotational direction.

Then, each of facing surfaces (end portions) of the first and second bearings 11, 12, which are arrange to face with each other with the intake air flow control valve 4 therebetween, includes a corresponding one of first and second contact portions 43, 44. Here, the first contact portion 43 contacts the left side face of the intake air flow control valve 4, and the second contact portion 44 contacts the right side face of the intake air flow control valve 4. There is an annular clearance formed between the outer peripheral surface of the first bearing slide portion 31 of the valve shaft 5 and the inner peripheral surface of the first slide hole 41 of the first bearing 11 such that the valve shaft 5 can smoothly rotate in the first slide hole 41 of the first bearing 11. Also, there is an annular clearance formed between the outer peripheral surface of the second bearing slide portion 32 of the valve shaft 5 and the inner peripheral surface of the second slide hole 42 of the second bearing 12 such that the valve shaft 5 can smoothly rotate in the second slide hole 42 of the second bearing 12. Also, the first bearing 11 integrally includes a first flange portion (first adjusting member) 45 on an outside end portion of the first bearing 11 in the longitudinal direction (on an opposite side of the first bearing 11 opposite from the intake air flow control valve 4). Here, the first flange portion 45 has an outer diameter larger than a hole diameter of the small hole portion of the first bearing support hole 21 of the first bearing holder 6. That is, the first flange portion 45 radially outwardly projects from the first bearing 11. Similarly, the second bearing 12 integrally includes a second flange portion (second adjusting member) 46 on an outside end portion of the second bearing 12 in the longitudinal direction (on an opposite side of the second bearing 12 opposite from the intake air flow control valve 4). Here, the second flange portion 46 has an outer diameter larger than a hole diameter of the small hole portion of the second bearing support hole 22 of the second bearing holder 7. In other words, the second flange portion 46 radially outwardly projects from the second bearing 12.

Here, the casing 1, the housing 3, the intake air flow control valve 4, and the first and second bearings 11, 12 are thermoplastic resin products (resin mold products). The thermoplastic resin products are manufactured (integrally molded with resin) using an injection molding method, where firstly a pellet resin material is melted with heat. Secondly the melted resin material is injected into cavities of an injection molding die by applying a pressure. Thirdly, the melted resin material is cooled for curing (hardening). Then, the resin material is taken out of the injection molding die. In consideration of heat-resistant performance and strength, a polyamide resin (PA), an unsaturated polyester resin (UP), a polyphenylene sulfide (PPS), or a polybutylene terephthalate (PBT) may preferably serve as the thermoplastic resin used for the casing 1, housing 3 and the intake air flow control valve 4.

A resin material with a high wearing characteristic and a high sliding characteristic (e.g., the polyamide resin (PA) thermoplastic resin) may preferably serve as the thermoplastic resin material used for the first and second bearings 11, 12. The first and second bearings 11, 12 may alternatively be integrally formed with a resin composite material, which includes the resin material and a low-friction-resistance material that is mixed with or added to the resin material. Here, the low-friction-resistance material includes a fluorine resin, such as polytetrafluoroethylene (PTFE). The resin composite material facilitates reducing the friction resistance caused by a relative movement of the valve shaft 5 of the intake air flow control valve 4 relative to the first and second bearings 11, 12.

An assembly method according to the first embodiment will be described. The assembly method of the internal combustion engine intake air flow control apparatus (intake air flow generating apparatus) according to the present embodiment will be briefly described with reference to FIGS. 1A to 3.

As shown in FIG. 1A, in a first step, the longitudinal end portions of the valve shaft 5, which is integrally formed with the intake air flow control valve 4, are assembled into the first and second bearing holders 6, 7 such that the longitudinal end portions of the valve shaft 5 are displaceable (rotatable) in the rotational direction. Thus, the intake air flow control valve 4 having the integrated valve shaft 5 is assembled into the housing 3 such that the intake air flow control valve 4 is displaceable (able to open and close, rotatable) in the rotational direction.

In a second step, as shown in FIG. 1A, each of the first and second bearings 11, 12 is inserted into a corresponding cylindrical tubular space (tubular clearance) from a corresponding longitudinal end side of the valve shaft 5 such that the first and second bearings 11, 12 are rotatably displaceable inside the first and second bearing holders 6, 7. Here, the cylindrical tubular spaces are formed between the inner periphery of each of the first and second bearing support holes 21, 22 and the outer periphery of the corresponding one of the first and second bearing slide portions 31, 32.

In a third step, as shown in FIG. 1B, the first and second contact portion 43, 44, which are provided to end portions of the first and second bearings 11, 12 in the insertion direction, are brought into contact with the left and right side face of the intake air flow control valve 4 with a very slight contact force such that the smooth rotatability of the intake air flow control valve 4 is not degraded. Alternatively, the longitudinal position of the intake air flow control valve 4 relative to the housing 3 is adjusted in a state where a slight clearance is formed at a contact surface between the longitudinal end portion (first (second) bearing slide portion 31 (32)) of the valve shaft 5 of the intake air flow control valve 4 and the first (second) bearing 11 (12). In the adjusting of the longitudinal position of the intake air flow control valve 4 relative to the housing 3, first and second spacers (e.g., annular insertion members not shown) are inserted into the spaces between each of the horizontal passage wall faces of the housing 3 and a corresponding one of the horizontal side faces of the intake air flow control valve 4 such that the side clearance δL is set generally equal to the side clearance δR. Each of the first and second spacers has a proper thickness for generally equalizing the side clearances δL, δR.

At this time, because the longitudinal position of the intake air flow control valve 4 relative to the housing 3 is controlled based on the first and second spacers, the first and second bearings 11, 12 can be inserted into the above cylindrical tubular spaces (tubular clearance) until the first and second contact portions 43, 44 of the first and second bearings 11, 12 contact the horizontal side faces of the intake air flow control valve 4. Thus, longitudinal positions of the first and second bearings 11, 12 relative to the first and second bearing holders 6, 7 are controlled at predetermined positions. Therefore, the side clearance δL and the side clearance δR are generally equalized (δL≅δR). Here, the side clearance δL is formed between the left passage wall face of the housing 3 and the left side face of the intake air flow control valve 4. The side clearance δR is formed between the right passage wall face of the housing 3 and the right side face of the intake air flow control valve 4.

Next, in a fourth step, each of the first and second bearings 11, 12 is fixed to the corresponding one of the first and second bearing holders 6, 7 of the housing 3. Specifically, each of the first and second bearings 11, 12 is supported by and fixed to an inner periphery of a corresponding one of the first and second bearing support holes 21, 22 of the first and second bearing holders 6, 7 by use of the welding method, such as a laser welding, a vibration welding. As an alternative assembly method, each of the first and second bearings 11, 12 may be press fitted into a corresponding inner periphery of the first and second bearing support holes 21, 22 of the first and second bearing holders 6, 7 for engagement. Here, the first and second spacers are removed from the spaces between the housing 3 and the intake air flow control valve 4 before or after the first and second bearings 11, 12 are fixed. As discussed above, the intake air flow control valve 4 and the first and second bearings 11, 12 are assembled into the resin housing 3 to form each valve unit 2. Then, each of the multiple valve units 2 is fitted into the corresponding one of multiple fit bores 13 of the casing 1. Then, by use of bolts, the casing 1 is fastened to and fixed to the cylinder head (or the intake manifold) of the engine with the gasket (annular gasket) 9 therebetween.

Operations of the internal combustion engine intake air flow control apparatus (intake air flow generating apparatus) according to the present embodiment will be briefly described with reference to FIGS. 1A to 3.

In a case where the tumble flow needs to be generated, each of the multi integrated intake air flow control valves 4 is closed such that the intake air, which is filtered through the air cleaner, is supplied to each intake port through the opening portion 29 of each intake air flow control valve 4 and through a vicinity of a passage wall face of the first air passage 15 located at the upper part. Then, the intake air is introduced to the combustion chamber of each cylinder of the engine passing by the intake valve. Most of the intake air introduced to the combustion chamber passes through the opening portion 29 of the intake air flow control valve 4. Thus, an air flow of the intake air introduced to the combustion chamber becomes a vortex flow in a vertical direction (the tumble flow).

In other words, the vortex flow in the vertical direction (the tumble flow) can be easily generated because the air-fuel mixture can be introduced to the combustion chamber through the opening portion 29 of the intake air flow control valve 4, the first air passage 15 (the upper portion of the intake air passage inside the intake manifold) and the upper portion of the intake port, when the intake air flow control valve 4 is located in the totally closed position. Therefore, the tumble flow, which facilitates burning the air-fuel mixture in the combustion chamber of each cylinder of the engine, can be actively generated. Thus, the mixture can be burned at a certain air-fuel ratio (a lean burn state), where the mixture otherwise cannot be easily burned, so that the fuel economy can be improved without degrading engine performance.

Also, in a state where the intake air flow control valve 4 is located in the totally closed position, air leakage from the side clearances δL, δR may be applied to fuel spray injected through the injection hole of the injector. In this case, the atomization of the fuel spray injected through the injection hole of the injector can be facilitated by use of the air leakage. This is referred as an air assisting function.

As described above, in the internal combustion engine intake air flow control apparatus (intake air flow generating apparatus), initially, the intake air flow control valve 4 having the valve shaft is assembled into the housing 3. Then, each of the first and second bearings 11, 12 is inserted between the inner periphery of each of the first and second bearing support holes 21, 22 of the first and second bearing holders 6, 7 of the housing 3 and the outer periphery of the corresponding one of the first and second bearing slide portions 31, 32 of the valve shaft 5 such that the first and second bearings 11, 12 are assembled into the first and second bearing holders 6, 7. Then, the first and second contact portions 43, 44, which are provided to the end portion of the first and second bearings 11, 12 in the insertion direction, are brought into contact with the left and right side faces of the intake air flow control valve 4 with the slight contact force such that the smooth rotatability of the intake air flow control valve 4 is not degraded.

Therefore, the side clearance δL and the side clearance δR are generally equalized (δL≅δR). Here, the side clearance δL is formed between the left side passage wall face of the housing 3 and the left side face of the intake air flow control valve 4. The side clearance δR is formed between the right side passage wall face of the housing 3 and the right side face of the intake air flow control valve 4. Thus, for example, the atomization of the fuel injected through the injection hole of the injector can be facilitated because the air leakage amount passing through the side clearance δL, δR can be generally equalized when the intake air flow control valve 4 is located in the totally closed position. Therefore, the engine performance and the fuel economy can be improved.

Wearing resistant components preferably include only the first and second bearings 11, 12. General inexpensive resin material (e.g., PPS, PBT, PA), which is not wearing resistant, may be used for the housing 3 and the intake air flow control valve 4 integrated with the valve shaft 5. In other words, the housing 3 and the intake air flow control valve 4 integrated with the valve shaft 5, all of which are comparatively physically large, are integrally formed with the inexpensive thermoplastic resin material. The first and second bearings 11, 12, which are comparatively physically small, are integrally formed with the resin composite material such that the cost can be reduced. Here, the resin composite material includes the thermoplastic resin material and the low friction resistance material (e.g., PTFE), which is mixed with or added to the thermoplastic resin material.

Also, in the valve units 2 of the present embodiment, the housing 3 is not elastically structured so that the housing 3 is not twisted even in a case where the valve unit 2 is assembled to the casing 1 and then the casing 1 is fastened to the cylinder head of the engine by using the fastening bolts. Therefore, deterioration of the coaxiality of the first and second bearing holders 6, 7 of the housing 3 can be limited. Thus, even when four valve units 2 are assembled to the casing 1, a shaft slide torque of the single valve shaft 10 is limited from increasing and the electric actuator can easily drive the intake air flow control valves 4.

(Second Embodiment)

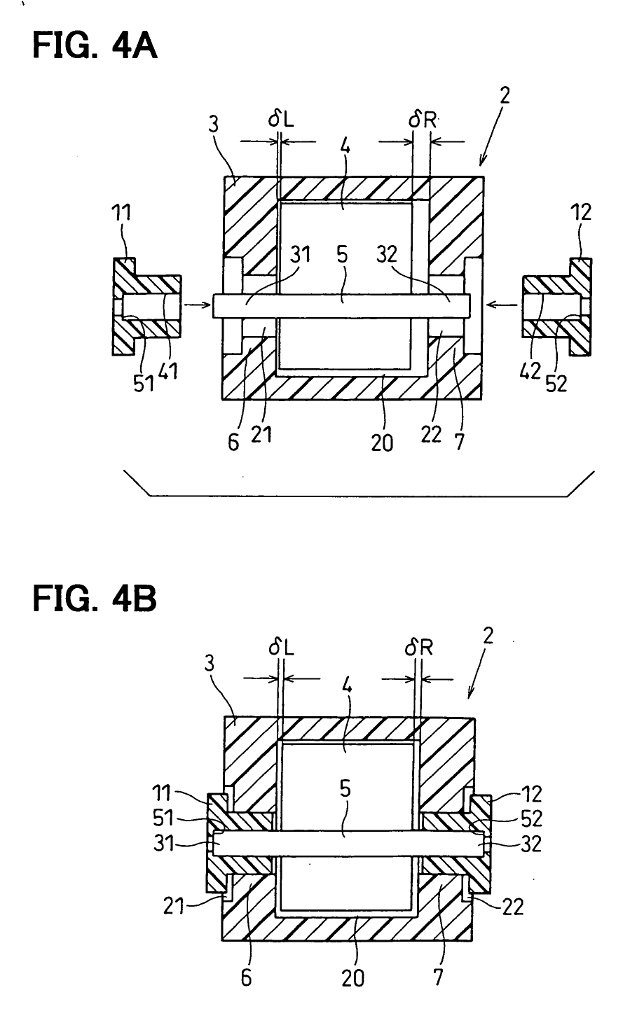

A second embodiment of the present invention will be described with reference to FIGS. 4A, 4B, which are diagrams of valve units according to the second embodiment. Similar components of an internal combustion engine intake air flow control apparatus of the present embodiment, which are similar to the components of the internal combustion engine intake air flow control apparatus of the first embodiment, will be indicated by the same numerals.

The first and second bearings 11, 12 of the present embodiment include the first and second slide holes 41, 42, which include first and second annular step surfaces (contact surfaces) 51, 52. Inner diameters of the first and second slide holes 41, 42 are larger on inner sides (the air passage side) relative to the first and second step surfaces 51, 52 than those on outer sides (opposite sides) relative to the first and second step surfaces 51, 52, the opposite side being located opposite from the air passage. The first step surface 51 of the first bearing 11 serves as a first contact surface that contacts a first longitudinal end face of the valve shaft 5. Also, the second step surface 52 of the second bearing 12 serves as a second contact surface that contacts a second longitudinal end face of the valve shaft 5. Here, the first and second longitudinal end faces are opposite faces of the valve shaft 5.

Then, an adjusting method for adjusting the longitudinal position of the intake air flow control valve 4 relative to the housing 3 in the longitudinal direction of the valve shaft 5 will be briefly described with reference to FIGS. 4A, 4B. As shown in FIG. 4A, the resin intake air flow control valve 4 is assembled into the resin housing 3 such that the intake air flow control valve 4 opens and closes. Then, each of the first and second bearings 11, 12 is inserted into the corresponding cylindrical tubular space (tubular clearance) from the corresponding longitudinal end side of the valve shaft 5. Here, the cylindrical tubular space is formed between the inner periphery of each of the first and second bearing holders 6, 7 and the outer periphery of the corresponding one of the first and second bearing slide portions 31, 32 of the valve shaft 5. Then, as shown in FIG. 4B, the longitudinal position of the intake air flow control valve 5 relative to the housing 3 is adjusted by bringing each of the first and second steps 51, 52 of the first and second bearings 11, 12 into contact with a corresponding longitudinal end face of the valve shaft 5.

In the adjusting of the longitudinal position of the intake air flow control valve 4 relative to the housing 3, each of clearance adjusting spacers (not shown) is inserted into the space between each of the horizontal passage wall faces (left and right passage wall faces) of the housing 3 and the corresponding one of the horizontal side faces (left and right side faces) of the intake air flow control valve 4. Then, each of the first and second bearings 11, 12 is fixed to the corresponding inner periphery of the first and second bearing holders 6, 7 of the housing 3 by use of the welding method, such as the laser welding, the vibration welding. Alternatively, each of the first and second bearings 11, 12 may be press fitted into the corresponding inner periphery of the first and second bearing holders 6, 7 of the housing 3 such that the first and second bearings 11, 12 are supported and fixed. Thus, the intake air flow control valve 4 is received in the air passage 20 of the housing 3 such that the intake air flow control valve 4 can open and close (rotate) in a state where the side clearance δL and the side clearance δR are generally equalized. The first embodiment and the second embodiment can be combined together.

(Third Embodiment)

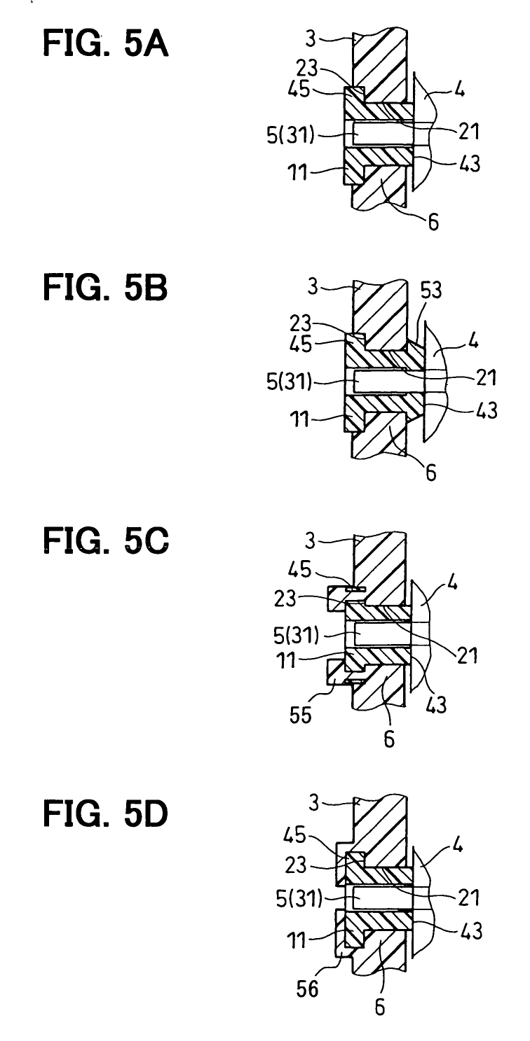

A third embodiment of the present invention will be described with reference to FIGS. 5A to 5D, which show a periphery of fist bearings according to the third embodiment of the present invention. Similar components of an internal combustion engine intake air flow control apparatus of the present embodiment, which are similar to the components of the internal combustion engine intake air flow control apparatus of the first embodiment, will be indicated by the same numerals.

In the present embodiment, the first and second bearing holders 6, 7 of the housing 3 include the first and second step surfaces (first and second engaging portion) 23, 24 that engage with annular end faces of the first and second flange portions (first and second engaged portions) 45, 46 of the first and second bearings 11,12. The first and second step surfaces 23, 24 serve as the longitudinal position control member that controls the longitudinal position of the first and second bearings 11, 12 relative to the first and second bearing support holes 21, 22 of the first and second bearing holders 6, 7 of the housing 3 respectively such that the side clearances δL, δR are generally equalized (δL≅δR).

In an adjusting method for adjusting the longitudinal position of the intake air flow control valve 4 in the valve shaft longitudinal direction according to the present embodiment, as shown in FIG. 5A, initially the first bearing 11 is inserted into a corresponding space until the annular end surface of the first flange portion 45 engages with (contacts) the first step surface 23. Here, the corresponding space is formed between the inner periphery of the first bearing holder 6 of the housing 3 and the outer periphery of the first bearing slide portion 31 of the valve shaft 5. Also, similar to this, the second bearing 12 is inserted into a corresponding space until the annular end surface of the second flange portion 46 engages with (contacts) the second step surface 24. Here, the corresponding space is formed between the inner periphery of the second bearing holder 7 of the housing 3 and the outer periphery of the second bearing slide portion 32 of the valve shaft 5.

At this time, the first contact portion 43, which is provided to the end portion of the first bearing 11 in the insertion direction, is exposed in the air passage 20 of the housing 3, and is brought into contact with the left side face of the intake air flow control valve 4 with the slight contact force such that the smooth rotatability of the intake air flow control valve 4 is not degraded. Simultaneously, the longitudinal position of the intake air flow control valve 4 relative to the housing 3 is adjusted. In this case, the spacers are not needed. Then, each of the first and second bearings 11,12 is fixed to the inner periphery of the corresponding one of the first and second bearing holders 6, 7 of the housing 3 by use of the welding method, such as the laser welding, the vibration welding.

Alternatively, in the present embodiment, as shown in FIG. 5B, the first bearing 11 can be supported by and fixed to the first bearing holder 6 of the housing 3 by use of a snap fit 53. Alternatively, in the present embodiment, as shown in FIGS. 5C, 5D, the first bearing 11 can be supported by and fixed to the first bearing holder 6 of the housing 3 by use of thermal caulking 55, 56. Each structure of the second bearing 12 and the second bearing holder 7 may be similar to a corresponding structure of the first bearing 11 and the first bearing holder 6.

(Fourth Embodiment)

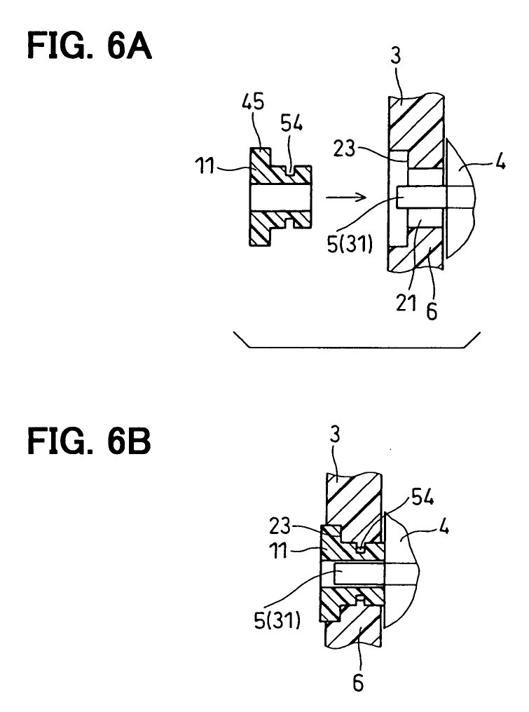

A fourth embodiment of the present invention will be described with reference to FIGS. 6A, 6B, which show a periphery of a first bearing according to the present embodiment. Similar components of an internal combustion engine intake air flow control apparatus of the present embodiment, which are similar to the components of the internal combustion engine intake air flow control apparatus of the first embodiment, will be indicated by the same numerals.

The housing 3 of the present embodiment is the thermoplastic resin product (the resin mold product). The thermoplastic resin product is manufactured (integrally molded with resin) using an injection molding method, where firstly the pellet resin material is melted with heat. Then, the melted resin material is injected into the cavity of the injection molding die by applying a pressure to the melted resin material. The housing 3 is taken out of the injection molding die before the housing 3 is cooled and is completely cured (hardened) so that each of the first (second) bearing 11 (12) is inserted into the space between the inner periphery of each of the first and second bearing holders 6, 7 and the outer periphery of the corresponding one of the first and second bearing slide portions 31, 32 by press (friction) fitting. Alternatively for preparation of the above press-fit insertion, the housing 3 may be reheated after the housing 3 has been completely cured.

Subsequently, when the housing 3 is cooled and cured, the press fit force (tension force) is increased due to shrinkage deformation of the housing 3 such that the first and second bearings 11, 12 are more securely supported and fixed to the inner peripheries of the first and second bearing holders 6, 7 of the housing 3. That is, the first and second bearings 11,12 are thermal press fitted bearings. The above bearings 11,12 are more securely supported and fixed to the housing 3 compared to the first and second bearings 11,12, which are insert molded to the inner periphery of the first and second bearing holders 6, 7. In a case where a groove 54 is circumferentially provided to a cylindrical tubular portion of each of the first and second bearings 11, 12, the first and second bearings 11,12 are securely supported and fixed to the inner peripheries of the first and second bearing holders 6, 7 of the housing 3 due to an anchor effect when the housing 3 is cooled and cured.

(Fifth Embodiment)

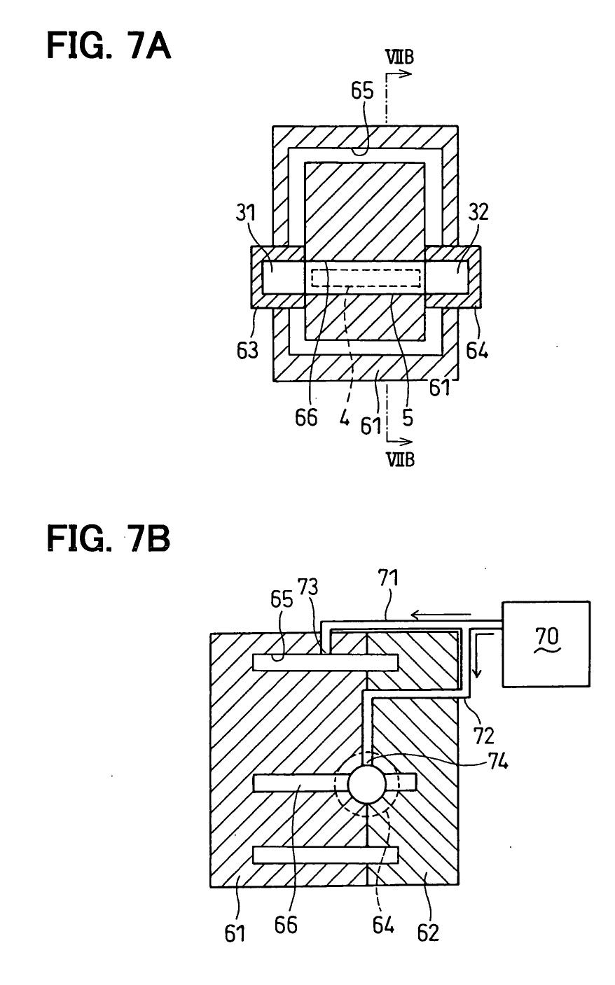

A fifth embodiment of the present invention will be described with reference to FIGS. 7A to 9B. Similar components of an internal combustion engine intake air flow control apparatus of the present embodiment, which are similar to the components of the internal combustion engine intake air flow control apparatus of the first embodiment, will be indicated by the same numerals.

An injection molding die (molding die) of the present embodiment includes a fixed die and a movable die, which is displaceable relative to the fixed die in a horizontal direction in FIG. 7B. As shown in FIGS. 7A, 7B, the fixed and movable dies, such as an A die 61, a B die 62, a C die 63, a D die 64, are provided Here, the A die 61 and the B die 62 serve to resin mold the rectangular valve portion of the intake air flow control valve 4 and a longitudinal center portion of the valve shaft 5. Also, the C die 63 resin molds the inner peripheral surface of the first bearing holder 6 of the housing 3 and the outer peripheral surface of the first bearing slide portion 31 of the valve shaft 5. The D die 64 resin molds the inner peripheral surface of the second bearing holder 7 of the housing 3 and the outer peripheral surface of the second bearing slide portion 32 of the valve shaft 5.

A cavity 65 and a cavity 66 are provided inside the injection molding die. Here, the cavity 65 is of a shape that corresponds to a product shape of the housing 3 and the cavity 66 is of a shape that corresponds to a product shape of the intake air flow control valve 4 integrated with the valve shaft 5. These cavities 65, 66 are connected with a resin material supply apparatus 70, which supplies a melt resin material into the injection molding die. The resin material supply apparatus 70 includes multiple resin supply passages 71, 72, each of which has a gate (resin filler inlet) 73, 74 at an end portion of the resin supply passage to inject the pellet resin material into the corresponding cavity 65, 66. In the present embodiment, in order to resin mold the housing 3 and the intake air flow control valve 4 generally at the same time in a common injection molding die, the cavities 65, 66 are formed of certain shapes. Due to the shapes, the intake air flow control valve 4 and the valve shaft 5 are resin molded with the thermoplastic resin material in a state where the intake air flow control valve 4 is rotatably assembled in the housing 3 and is located in the totally open position.

Firstly, in an injection/filling step, the melt resin (i.e., a pellet thermoplastic resin material melted with heat) is supplied from the resin material supply apparatus 70 to the gates 73, 74 through the multiple resin supply passages 71, 72. Then, the melted resin is injected into the injection molding die through the gates 73, 74 such that the cavities 65, 66, which are formed by the injection molding die, are filled with the melted resin.

Then, in a pressure holding step, an internal die resin pressure is gradually increased to be kept at a certain internal die resin pressure larger than a maximum internal resin pressure at a time of injection. In other words, a predetermined pressure is applied to the melted resin in the injection molding die, and a coolant is introduced to a coolant passage (not shown), which is provided to the cavities 65, 66 of the injection molding die. In this condition, the melted resin is supplied to the cavities 65, 66 through the gates 73, 74 by an amount that corresponds to a shrink amount of the melted resin due to the coolant.

Then, the melted resin, which fills the injection molding die, is taken out and is cured (hardened) by cooling at a normal temperature. Alternatively, the melted resin is cured (hardened) in the injection molding die by cooling the melted resin using the coolant. Then, by the injection molding of the resin material, the thermoplastic resin product (resin mold product) is manufactured in a state where the intake air flow control valve 4 (and the valve shaft 5) is rotatably assembled inside the housing 3. Thus, the number of the components and manpower for assembly can be reduced so that the manufacturing cost can be reduced.

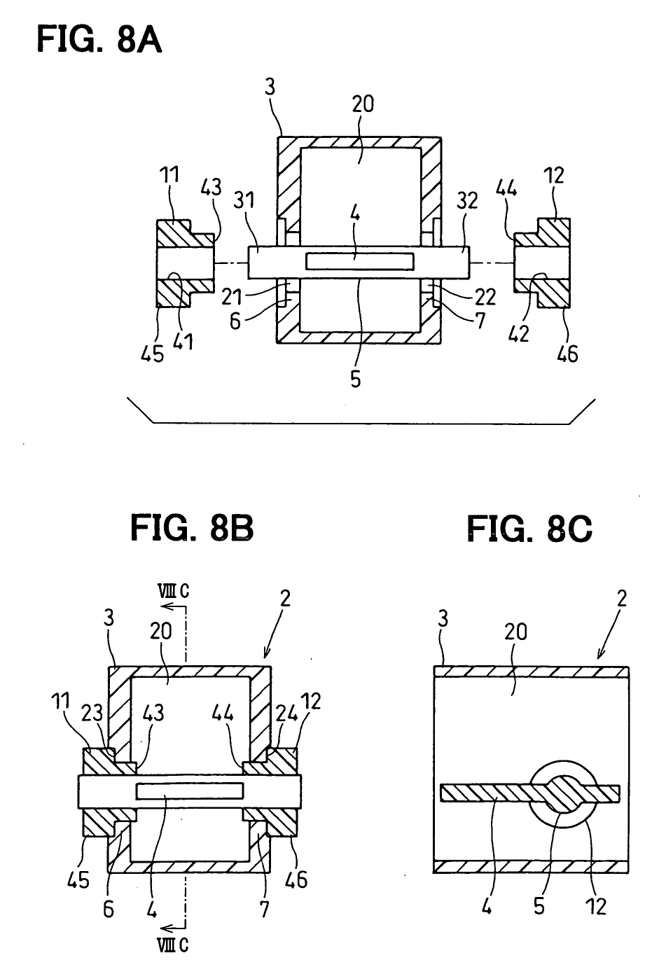

In an adjusting method for adjusting the longitudinal position of the intake air flow control valve 4 according to the present embodiment, as shown in FIG. 8A, initially the first bearing 11 is inserted into the corresponding space until the annular end surface of the first flange portion 45 engages with (contacts) the first step surface 23. Here, the corresponding space is formed between the inner periphery of the first bearing holder 6 of the housing 3 and the outer periphery of the first bearing slide portion 31 of the valve shaft 5. Also, similar to this, the second bearing 12 is inserted into the corresponding space until the annular end surface of the second flange portion 46 engages with (contacts) the second step surface 24. Here, the corresponding space is formed between the inner periphery of the second bearing holder 7 of the housing 3 and the outer periphery of the second bearing slide portion 32 of the valve shaft 5.

At this time, as shown in FIG. 8B, the first contact portion 43, which is provided to the end portion of the first bearing 11 in the insertion direction, is exposed to the air passage 20 of the housing 3, and is brought into contact with the left side face of the intake air flow control valve 4 with the slight contact force such that the smooth rotatability of the intake air flow control valve 4 is not degraded. Thus, the insertion position of the first bearing 11 is controlled by the fist step surface 23, and at the same time the longitudinal position of the intake air flow control valve 4 relative to the housing 3 is adjusted. The second bearing 12 is similarly inserted and adjusted. In the above case, the spacers are not needed. Then, each of the first and second bearings 11, 12 is fixed to the inner periphery of the corresponding one of the first and second bearing holders 6, 7 of the housing 3 by use of the welding method, such as the laser welding, the vibration welding.

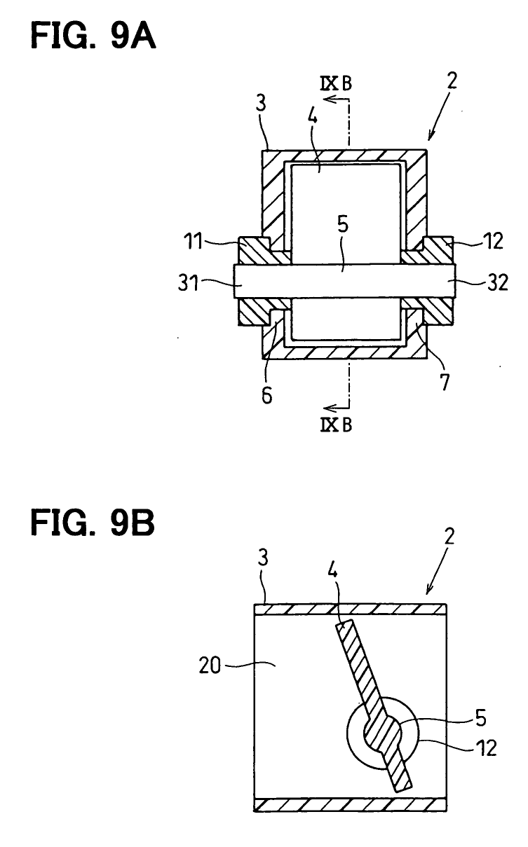

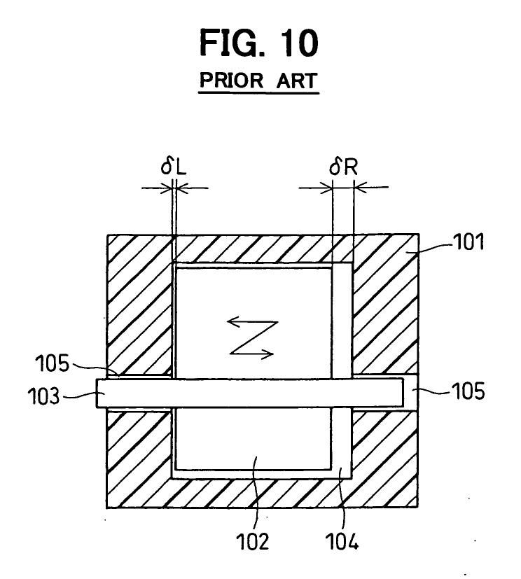

The intake air flow control valve 4 according to the present embodiment is set such that the rotation axis direction of the intake air flow control valve 4 (the longitudinal direction of the valve shaft 5) is orthogonal to the flow axis direction of the average flow of the intake air that passes through the air passage 20 of the housing 3. Then, the intake air flow control valve 4 controls the amount of the intake air supplied to the combustion chamber of each cylinder of the engine by changing the rotation angle (valve opening degree) of the control valve 4 from the totally open position (see FIGS. 8B to 8C) to the totally closed position (see FIGS. 9A, 9B). Here, when the intake air flow control valve 4 is located in the totally open position, the flow amount of the intake air that passes through the air passage of the housing 3 is maximized. Also, when the intake air flow control valve 4 is located in the totally closed position, the flow amount of the intake air that passes through the air passage of the housing 3 is minimized. Here, the intake air flow control valve 4 is spring biased by a coil spring (not shown) toward the totally open position.

Modification of the above embodiments will be described. In the above embodiments, the internal combustion engine intake air flow control apparatus (intake air flow generating apparatus, vortex flow generating apparatus) is structured to generate the intake air vortex flow in the vertical direction (tumble flow) for facilitating the combustion of air-fuel mixture in each cylinder of the engine. However, the internal combustion engine intake air flow control apparatus may be alternatively structured to generate the intake air vortex flow in a horizontal direction (swirl flow) for facilitating the combustion of air-fuel mixture in each cylinder of the engine. Also, the internal combustion engine intake air flow control apparatus may be alternatively structured to generate a squish curl for facilitating the combustion in the engine.

In the above embodiments, the fluid control apparatus of the present invention is applied to the internal combustion engine intake air flow control apparatus that controls the intake air supplied to the combustion chamber of each cylinder of the internal combustion engine. However, the fluid control apparatus of the present invention may be alternatively applied to an internal combustion engine intake air control apparatus that controls the flow amount of the intake air supplied to the combustion chamber of each cylinder of the internal combustion engine. In this case, an intake air flow rate control valve, such as an idling rotational speed control valve, a throttle valve, is assembled inside the housing. Also, the fluid control apparatus of the present invention may be alternatively applied to an exhaust gas recirculation apparatus having an exhaust gas recirculation (ERG) control valve. Here, the ERG control valve controls a recirculation amount of exhaust gas in a system, in which a part of the exhaust gas from the engine is recirculated into the intake air passage.

Also, the fluid control apparatus of the present invention may be alternatively applied to an internal combustion engine variable intake air apparatus that includes a variable intake valve. The variable intake valve serves as an internal combustion engine intake air control valve that changes a length or a sectional area of the intake air passage of the intake manifold in relation to the engine rotational speed. For example, when the engine rotational speed stays in a low or medium speed range, the internal combustion engine variable intake air apparatus switches the intake passage of the intake manifold by use of the variable intake valve such that the length of the intake passage is elongated. When the engine rotational speed stays in a high speed range, the internal combustion engine variable intake air apparatus switches the intake passage of the intake manifold by use of the variable intake valve such that the length of the intake passage is shortened. In this way, the internal combustion engine variable intake air apparatus can improve the engine output shaft torque (engine torque) regardless of the engine rotational speed. Also, the fluid is not limited to gas, such as the intake air or exhaust gas. However, liquid, such as water or oil, may be used.

In the above embodiments, the valve drive apparatus for opening and closing operations of the intake air flow control valve 4 includes the electric actuator with the power unit. The power unit includes the electric motor and the power transmission mechanism (e.g., the gear reducer mechanism). However, the valve drive apparatus may be alternatively a vacuum actuator or a solenoid actuator. Here, the vacuum actuator has a solenoid vacuum valve or an electric vacuum valve. A valve biasing member, such as a spring, which biases the valve toward the opening or closing direction, is not needed. In the above embodiments, the butterfly valve, which rotates about the rotation axis of the valve shaft 5, serves as the valve to describe the embodiments. However, an alternative valve, such as a plate valve, a rotary valve, may be used.

In the above embodiments, the present invention is applied to the inline four-cylinder engine, in which the cylinders are arranged in a group. However, the present invention may be alternatively applied to an internal combustion engine, which includes a plurality of banks having a group of arranged cylinders. The above alternative internal combustion engine includes a multiple cylinder engine, such as a V-type engine, a horizontal engine, a horizontal opposed engine. Also, in the above embodiments, the first and second bearings 11, 12 are made of the resin material. However, both the first and second bearings 11, 12 are made of a metallic material. Also, the valve is not limited to the multi integrated valve. However, the valve may be alternatively a single valve as long as the single valve is integrated with the valve shaft.

Additional advantages and modifications will readily occur to those skilled in the art. The invention in its broader terms is therefore not limited to the specific details, representative apparatus, and illustrative examples shown and described.

What is claimed is:

1. A manufacturing method of a fluid control apparatus comprising:
assembling a valve that is integrally formed with a valve shaft inside a housing;
assembling first and second bearing members inside the housing by inserting each of the first and second bearing members into a corresponding space between the housing and the valve shaft from a corresponding longitudinal end side of the valve shaft; and
adjusting a longitudinal position of the valve relative to the housing in a longitudinal direction of the valve shaft through one of the followings:
by bringing a first contact portion of the first bearing member into contact with a first side face of the valve and bringing a second contact portion of the second bearing member into contact with a second side face of the valve; and
by bringing a first contact surface of the first bearing member into contact with a first longitudinal end face of the valve shaft and bringing a second contact surface of the second bearing member into contact with a second longitudinal end face of the valve shaft.

2. The manufacturing method according to claim 1, wherein the adjusting of the longitudinal position of the valve includes inserting each of at least one insertion member into a corresponding one of the followings:
a first side clearance between a first wall face of the housing and the first side face of the valve; and
a second clearance between a second wall face of the housing and the second side face of the valve such that the first side clearance and the second side clearance are generally equalized.

3. The manufacturing method according to claim 1, wherein:
the housing is made of a resin material and includes a fluid passage inside the housing;
the valve is made of a resin material and is received in the housing such that the valve opens and closes the fluid passage to control fluid that passes through the fluid passage; and
the first and second bearing members are received inside the housing such that each of the first and second bearing members slidably pivotally supports a corresponding longitudinal end portion of the valve shaft, whereby the valve shaft is rotatable in a rotation direction.

4. The manufacturing method according to claim 2, wherein each of the at least one insertion member has a predetermined shape such that the first side clearance and the second side clearance are generally equalized.

5. A fluid control apparatus, comprising:
a resin housing that includes a fluid passage inside the housing;
a resin valve that is received in the housing such that the valve opens and closes the fluid passage to control fluid that passes through the fluid passage;
a valve shaft that is formed integrally with the valve; and
first and second bearing members that are received inside the housing such that each of the first and second bearing members slidably pivotally supports a corresponding longitudinal end portion of the valve shaft, the valve shaft being rotatable in a rotation direction, wherein:
the first bearing member includes one of the followings:
a first contact portion that contacts a first side face of the valve; and
a first contact surface that contacts a first longitudinal end face of the valve shaft;
the second bearing member includes one of the followings:
a second contact portion that contacts a second side face of the valve; and
a second contact surface that contacts a second longitudinal end face of the valve shaft; and
the housing includes a longitudinal position control member that controls a longitudinal position of each of the first and second bearing members relative to the housing in a longitudinal direction of the valve shaft such that a first side clearance between a first wall face of the housing and the first side face of the valve is generally equalized to a second side clearance between a second wall face of the housing and the second side face of the valve.

6. The fluid control apparatus according to claim 5, wherein:
the housing includes a first bearing receiving member on a first longitudinal end of the housing in the longitudinal direction of the valve shaft, the first bearing receiving member supporting the first bearing member;
the housing includes a second bearing receiving member on a second longitudinal end of the housing in the longitudinal direction of the valve shaft, the second bearing receiving member supporting the second bearing member; and
the longitudinal position control member includes first and second engaging members, each of which engages with a corresponding one of the first and second bearing members such that a longitudinal position of each of the first and second bearing members relative to a corresponding one of the first and second bearing receiving members is controlled.

7. The fluid control apparatus according to claim 5, wherein at least one of the first and second bearing members is integrally formed by use of a resin composite material, which includes a resin material and a low friction resistance material that is mixed with or added to the resin material.

8. The fluid control apparatus according to claim 5, wherein the valve and the valve shaft are injection molded by a common molding die generally simultaneously when the housing is molded by the common molding die.

9. The fluid control apparatus according to claim 5, wherein an average flow direction of fluid that passes through the fluid passage is generally orthogonal to the longitudinal direction of the valve shaft.

10. A fluid control apparatus, comprising:
a resin housing that includes a fluid passage inside the housing;
a resin valve that is received in the housing such that the valve opens and closes the fluid passage to control fluid that passes through the fluid passage;
a valve shaft that is formed integrally with the valve; and
first and second bearing members that are received inside the housing such that each of the first and second bearing members slidably pivotally supports a corresponding longitudinal end portion of the valve shaft, the valve shaft being rotatable in a rotation direction, wherein at least one of the first and second bearing members is integrally formed by use of a resin composite material, which includes a resin material and a low friction resistance material that is mixed with or added to the resin material.

11. The fluid control apparatus according to claim 10, wherein the valve and the valve shaft are injection molded by a common molding die generally simultaneously when the housing is molded by the common molding die.

12. A fluid control apparatus, comprising:
a resin housing that includes a fluid passage inside the housing;
a resin valve that is received in the housing such that the valve opens and closes the fluid passage to control fluid that passes through the fluid passage;
a valve shaft that is formed integrally with the valve; and
first and second bearing members that are received inside the housing such that each of the first and second bearing members slidably pivotally supports a corresponding longitudinal end portion of the valve shaft, the valve shaft being rotatable in a rotation direction, wherein:
the first bearing member includes a first adjusting member, through which the first bearing member engages with the housing at a first position relative to the housing; and
the second bearing member includes a second adjusting member, through which the second bearing member engages with the housing at a second position relative to the housing.

13. The fluid control apparatus according to claim 12, wherein:
the first adjusting member radially outwardly projects from the first bearing member; and
the second adjusting member radially outwardly projects from the second bearing member.

14. The fluid control apparatus according to claim 12, wherein:
the first bearing member includes a first contact portion that contacts a first side face of the valve in a state where the first adjusting member engages with the housing at the first position relative to the housing; and
the second bearing member includes a second contact portion that contacts a second side face of the valve in a state where the second adjusting member engages with the housing at the second position relative to the housing.

15. The fluid control apparatus according to claim 12, wherein:
the first bearing member includes a first contact surface that contacts a first longitudinal end face of the valve shaft in a state where the first adjusting member engages with the housing at the first position relative to the housing; and
the second bearing member includes a second contact surface that contacts a second longitudinal end face of the valve shaft in a state where the second adjusting member engages with the housing at the second position relative to the housing.

16. The fluid control apparatus according to claim 12, wherein at least one of the first and second bearing members is integrally formed by use of a resin composite material, which includes a resin material and a low friction resistance material that is mixed with or added to the resin material.

17. The fluid control apparatus according to claim 12, wherein the valve and the valve shaft are injection molded by a common molding die generally simultaneously when the housing is molded by the common molding die.

18. The fluid control apparatus according to claim 12, wherein a first side clearance between a first wall face of the housing and a first side face of the valve is generally equalized to a second side clearance between a second wall face of the housing and a second side face of the valve in a state where the first bearing member engages with the housing at the first position relative to the housing and the second bearing member engages with the housing at the second position relative to the housing.
